(19) United States
(12) Patent Application Publication
(10) Pub. No.: US 2021/0232955 A1
(43) Pub. Date: Jul. 29, 2021

(54) HANDLING INFERENCES IN AN ARTIFICIAL INTELLIGENCE SYSTEM

(71) Applicant: International Business Machines Corporation, Armonk, NY (US)

(72) Inventors: Alfredo Alba, Morgan Hill, CA (US); Daniel Gruhl, San Jose, CA (US); Chad Eric DeLuca, Morgan Hill, CA (US); Petar Ristoski, San Jose, CA (US); Christian B. Kau, Mountain View, CA (US); Anna Lisa Gentile, San Jose, CA (US); Linda Ha Kato, San Jose, CA (US); Steven R. Welch, Gilroy, CA (US)

(21) Appl. No.: 16/775,365

(22) Filed: Jan. 29, 2020

(51) Int. Cl. G06N 5/04; G06F 40/205; G06F 40/268; G06N 3/04

(52) U.S. Cl. CPC G06N 5/045; G06F 40/205; G06N 5/042; G06N 3/0472; G06N 5/046; G06F 40/268

(57) ABSTRACT

Technology for using a computing device to interpret entity and relationship occurrences a natural language understanding system that includes the following operations (not necessarily in the following order): (i) receiving a corpus that includes unstructured data and/or structured data; (ii) parsing the corpus to obtain parsed corpus information; (iii) applying artificial intelligence to the parsed corpus information to determine a plurality of logical relationships manifested by the corpus; and (iv) expressing, by machine logic, the plurality of logical relationships as a respectively corresponding plurality of logical rule expressions, with each logical rule expression of the plurality of logical rule expressions expressing the respectively corresponding logical relationship as fact(s) with regard to the corpus.

### BACKGROUND

AI (artificial intelligence), from rule based to deep, involves extracting facts within a given corpora, preferably with great accuracy. Multiple features sources include: (i) entities from unstructured text; (ii) structured data from forms associated with the documents or otherwise; (iii) entities from images associated with the document; and (iv) structured or unstructured data collected from data center hosts. The data supports “facts” or assertions. For example, a server may have six (6) disks (which is a numerical fact). As a further example, a patient may be on a baby aspirin regime (which is a “boolean fact”). As a further example, a database may not be backed up by any of the five (5) approved back up systems (which is a more complex, computed fact). Once these facts are gathered, a set of “rules” describe how the world should work. For example, a critical systems must be backed up, and that they should not talk to outside ip (Internet protocol) addresses.

As of 4 Dec. 2019, the Wikipedia entry for “artificial intelligence” states, in part, as follows: “In computer science, artificial intelligence (AI), sometimes called machine intelligence, is intelligence demonstrated by machines, in contrast to the natural intelligence displayed by humans. Leading AI textbooks define the field as the study of “intelligent agents”: any device that perceives its environment and takes actions that maximize its chance of successfully achieving its goals. Colloquially, the term “artificial intelligence” is often used to describe machines (or computers) that mimic “cognitive” functions that humans associate with the human mind, such as “learning” and “problem solving”. As machines become increasingly capable, tasks considered to require “intelligence” are often removed from the definition of AI, a phenomenon known as the AI effect . . . . Modern machine capabilities generally classified as AI include successfully understanding human speech, competing at the highest level in strategic game systems (such as chess and Go), autonomously operating cars, intelligent routing in content delivery networks, and military simulations . . . . The traditional problems (or goals) of AI research include reasoning, knowledge representation, planning, learning, natural language processing, perception and the ability to move and manipulate objects. General intelligence is among the field's long-term goals. Approaches include statistical methods, computational intelligence, and traditional symbolic AI. Many tools are used in AI, including versions of search and mathematical optimization, artificial neural networks, and methods based on statistics, probability and economics.” (Footnotes omitted)

### SUMMARY

According to an aspect of the present invention, there is a method, computer program product and/or system that performs the following operations (not necessarily in the following order): (i) receiving a corpus that includes structured data; (ii) parsing the corpus to obtain parsed corpus information; (iii) applying artificial intelligence to the parsed corpus information to determine a plurality of logical relationships manifested by the corpus; and (iv) expressing, by machine logic, the plurality of logical relationships as a respectively corresponding plurality of logical rule expressions, with each logical rule expression of the plurality of logical rule expressions expressing the respectively corresponding logical relationship as fact(s) with regard to the corpus.

According to a further aspect of the present invention, there is a method, computer program product and/or system that performs the following operations (not necessarily in the following order): (i) receiving a corpus that includes unstructured data; (ii) parsing the corpus to obtain parsed corpus information; (iii) applying artificial intelligence to the parsed corpus information to determine a plurality of logical relationships manifested by the corpus; and (iv) expressing, by machine logic, the plurality of logical relationships as a respectively corresponding plurality of logical rule expressions, with each logical rule expression of the plurality of logical rule expressions expressing the respectively corresponding logical relationship as fact(s) with regard to the corpus.

According to a further aspect of the present invention, there is a method, computer program product and/or system that performs the following operations (not necessarily in the following order): (i) receiving a corpus that includes both unstructured data and structured data; (ii) parsing the corpus to obtain parsed corpus information; (iii) applying artificial intelligence to the parsed corpus information to determine a plurality of logical relationships manifested by the corpus; and (iv) expressing, by machine logic, the plurality of logical relationships as a respectively corresponding plurality of logical rule expressions, with each logical rule expression of the plurality of logical rule expressions expressing the respectively corresponding logical relationship as fact(s) with regard to the corpus.

### BRIEF DESCRIPTION OF THE DRAWINGS

FIG. 1 is a block diagram of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view of certain information generated by an embodiment of the present invention;

FIG. 5 is a flowchart showing a second embodiment of a method according to the present invention; and

FIG. 6 is a system diagram is a block diagram of a second embodiment of a system according to the present invention.

### DETAILED DESCRIPTION

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

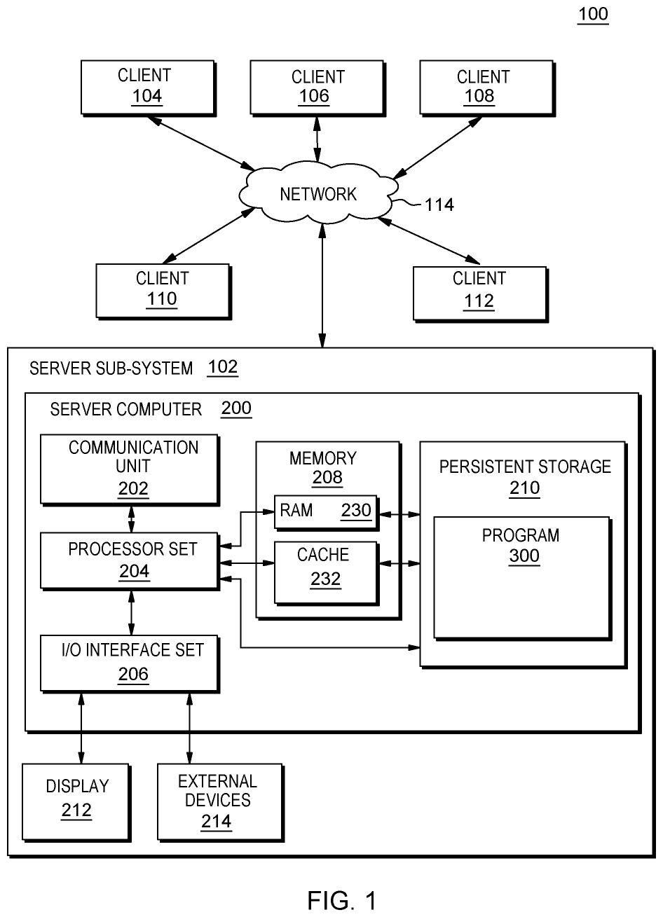

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

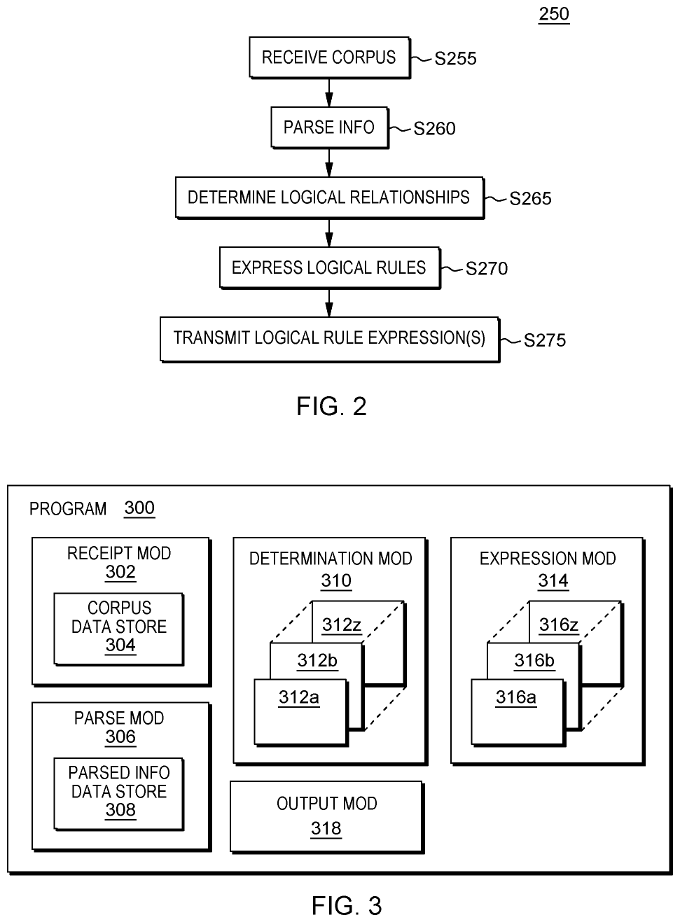

As shown in FIG. 1, networked computers system 100 is an environment in which an example method according to the present invention can be performed. As shown in FIG. 2, flowchart 250 shows an example method according to the present invention. As shown in FIG. 3, program 300 performs or control performance of at least some of the method operations of flowchart 250. This method and associated software will now be discussed, over the course of the following paragraphs, with extensive reference to the blocks of FIGS. 1, 2 and 3.

The method of flowchart 250 uses a computing device to interpret entity and relationship occurrences in a natural language understanding system. Processing begins at operation S255, where receipt module (“mod”) 302 receives a corpus of text into corpus data store 304. The text of corpus data store 304 includes either or both of the following: (i) structured information (for example tables with data, spreadsheets, etc.); and/or (ii) unstructured information (for example, the text of a novel).

Processing proceeds to operation S260, where parse mod 306 parses the corpus of text into structured data and unstructured data and stores it in parsed info data store 308.

Processing proceeds to operation S265, where determination mod 310 determines logical relationships (stored as relationship data 312a to 312z) between the structured data and the unstructured data of the information in parsed info data store 308.

Processing proceeds to operation S270, where expression mod 314 expresses the logical relationships, previously determined at operation S265, as logical rule expressions 316a to 316z. Logical rule expressions 316a to 316z, corresponding to relationship data 312a to 312z are expressed as fact(s) with regard to the corpus.

Processing proceeds to operation S275, where output mod 318 transmits at least one of the logical rule expressions 316a to 316z, in human understandable form and format, to a human user(s). In this embodiment, output mod 318 converts the logical rule expression(s) into a human understandable form and format, for transmission to human(s), using natural language processing software.

An abbreviated example of an embodiment of the present invention will now be given using a corpus made up of three (3) very brief short stories. Because of the very small corpus, this embodiment is not particularly realistic, but hopefully it is useful for pedagogical purposes.

SHORT STORY 1: My Lost Feather Duster. Kumar sat in the living room, looking around apprehensively for his feather duster. “I am quite sure that I left the feather duster in the living room,” said Kumar to nobody, as the living room was devoid of other humans. In point of fact, the feather duster was perched on the high mantle—so high that Kumar could not spot it from his current location seated on the divan. In frustration, Kumar stood up and exclaimed, “By hook, or by crook, I am well-determined to find that feather duster, even if I have to start looking in other rooms!” Just as these words had tumbled out of Kumar's mouth, he caught sight of the feather duster sitting on the mantle, just where he had left it the day before. Kumar grabbed the feather duster and began dusting the mantle, even though the mantle was not particularly dusty—such was his joy at having found the missing implement. THE END.

SHORT STORY 2: The Dusty Adjustable Desk. Qian put down her feather duster when the delivery robots delivered her adjustable desk. This adjustable desk could be adjusted between a low position for a seated user and a high position so that one could work while standing. Qian was quite excited by the prospect of using the desk because she liked to work standing up, for health benefits, but could not work that way all day—she had to sit for a spell sometimes to rest her tired arches. Qian was a hard worker who worked long hours and produced serviceable, though unspectacular, output. After spending a couple of minutes examining the desk, Qian concluded that it was in working order, but too dusty to use. Accordingly, she grabbed the feather duster that she had put down a few minutes earlier, and used it to expel the dust from the top surface of the adjustable desk. Then she got to work . . . . THE END.

SHORT STORY 3: Wet My Bird Beak. A feather duster sat on the window sill of the open window. A bird flew by, and thought to herself, “That looks like my son because of all the brightly colored feathers.” She flew to the window sill and perched upon it for a closer look. Upon close inspection, the bird became profoundly uncertain as to whether the feather duster was her son or some other bird. It never occurred to the bird that the feather duster was actually a feather duster and not a bird. To err on the side of caution, the bird picked up the feather duster in her beak and commenced flying towards the family nest. During the voyage it began to rain buckets, but the bird flew on, feather duster firmly in beak. However, as the rain continued, the bird's beak became wet, as did the portion of the feather duster that was gripped by the beak. The water acted as sort of a natural lubricant and the feather duster slipped out of the bird's beak and plummeted to the ground. By this time the bird had concluded that the feather duster was not her son because it never seemed to move of its own volition, the way her son did. The feather duster landed next to Valentina's bicycle. After the rain abated and the sun had burned off the moisture, Valentina came out to ride her bicycle. She noticed the abandoned feather duster and dusted off her bicycle seat before alighting upon the bike and pedaling off to go see a movie with her friends Qian and Kumar. THE END.

In this embodiment, the logical expressions for two rules are determined by artificial intelligence as follows: (i) in short stories, if there is a title, then the title has four (4) words; and (ii) in short stories, if a feather duster appears early in the story, then the feather duster will be used to dust an object later on in the short story. It is noted that these two (2) rules are expressed in human understandable form and format because they are expressed in a natural language. It is further noted that these rules are expressed as facts because while these rules are conditional statements, having a triggering predicate portion (for example, “if there is a title”), the consequential portions of these if-then statements (for example, “the title has four (4) words”) are expressed as “facts.” For a further discussion of the meaning of the term “facts,” as used herein, see the Background section and also the following subsection of this Detailed Disclosure section.

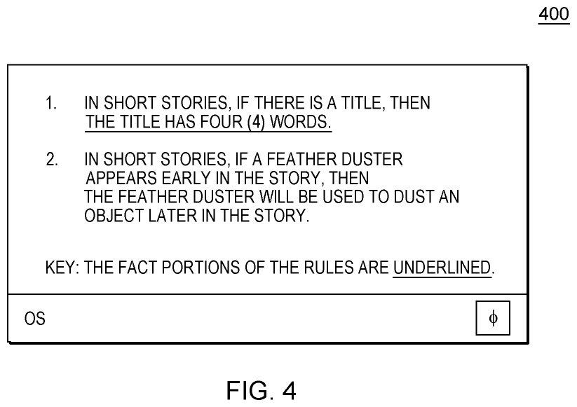

Screenshot 400 of FIG. 4 shows the two rules, derived by AI and expressed as facts, as they are displayed to a human user in human understandable form and format.

### III. Further Comments and/or Embodiments

Some embodiments of the present invention may recognize one, or more, of the following problems, opportunities for improvement, challenges and or shortcomings with respect to the currently conventional art: (i) based on the facts conclusions need to be derived; (ii) reasoning helps the human at: (a) the particular task of deriving actionable insights, (b) identifying any rules in a given set which prevent satisfiability, (c) use the knowledge at hand along with the facts contained within a corpus to prove or disprove a specific hypothesis, and/or (d) fully explained and supported the proof based on the facts, and available knowledge (rule sets) known to the system; (iii) best practices or guidelines applications of reasoners enables a mathematically provable determination of whether there is enough evidence or not support specific hypothesis and/or conclusions can be derived from the data; (iv) whether the facts in the data support any specific violations to any of the policies and best practices encoded in the rule sets; (v) a reasoner can be implemented as a backward or forward chaining collection of rulesets which renders a system to be fully auditable down to the facts and rules that support or negate any specific conclusion; and/or (vi) mathematically provable inference over the conclusions of an AI system based on a given ontology.

Some embodiments of the present invention may recognize one, or more, of the following problems, opportunities for improvement, challenges and or shortcomings with respect to the currently conventional art: (i) applying machine logic based rules that human clients can understand an audit is relatively easy as long as the “facts” are fairly easy to understand and any non-adherence to the rules is easy to compute and explain; and/or (ii) it becomes useful to be able to compute satisfiability and answer the following questions: (a) can a particular rule set ever be satisfied; (b) are there many conflicting rules which place that rules set into a Catch-22 situation; and (c) are exceptions are easy to spot.

A couple of examples where it becomes useful to be able to compute satisfiability and answer the questions, posed in the previous paragraph, will now be set forth: (i) whether there is a patient's treatment plan which conflicts with best practice guidelines; (ii) whether solutions can be identified; (iii) whether a set of things are wrong with a data center; (iv) whether there is a single “offering package” which will address most them (if not all); and (v) if not all, then which ones.

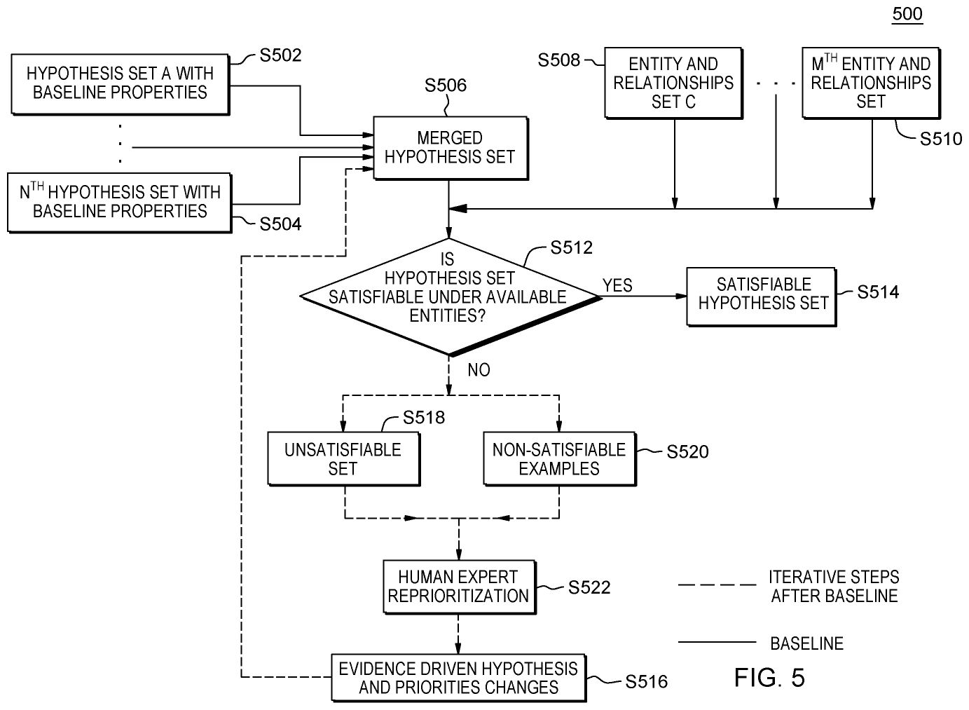

As shown in the flowchart 500 of FIG. 5, hypothesis satisfiability can be determined for n hypothesis sets and m domain specific entities relationships sets, as now will be discussed in the following paragraphs.

Processing begins at where operation S502 (hypothesis set A with baseline priorities) module and operation S504 (“n”th hypothesis set with baseline priorities) module, combine into operation S506 (merged hypothesis set) module.

Processing proceeds where operation S506 along with operation S508 (entity and relationship set C) module merges with operation S510 (“m”th entity and relationships set) module into operation S512 (is hypothesis set satisfiable under available entities) module.

Processing continues inside operation S512 (is hypothesis set satisfiable under available entities) module where the question is evaluated. If the answer to the question is yes, processing continues to operation S514 (satisfiable hypothesis set) module, where the process ends. If the answer to the question is no, processing continues to both operation S518 (unsatisfiable sets) module and operation S520 (non-satisfiable examples) module.

Processing continues to operation S522 (human expert reprioritization) module, then onto operation S516 (evidence driven hypothesis and priorities changes) module and then back to operation S506 (merged hypothesis set) module.

Note that operations S502, S504, S506, S508, S510, S512 and S514 above are baseline operations (steps) Likewise, operations S516, S518, S520, and S522 above are interactive operations (steps) after baseline.

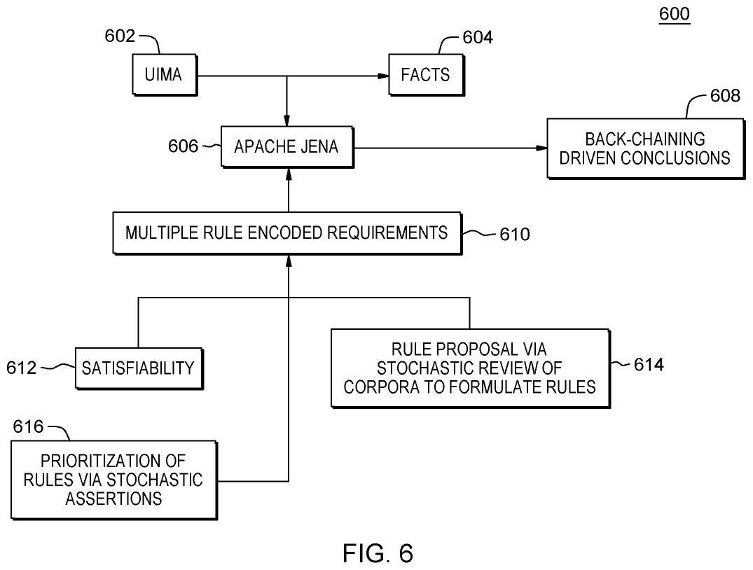

As shown in FIG. 6, higher level first order reasoning exemplar system 600 includes: UIMA (unstructured information management architecture) block 602; facts block 604; apache jena block 606; back-chaining driven conclusions block 608; multiple rule encoded requirements block 610; satisfiability block 612; rule proposal via stochastic review of corpora to formulate rules block 614; and prioritization of rules stochastic assertions block 616.

Various embodiments of the present invention may be used in various different fields where artificial intelligence systems are employed, such as: (i) data centers, which are typically characterized by the following features: (a) functional rule encoders examples (fact leads to fact), (b) external communications, (c) workload, (d) stack detection, (e) physical survey, and (f) best practices encoded as rules to detect violations in the form of recommendations; and/or (ii) medical imaging applications that include machine logic-based rules for different reporting guidance elements such as: (a) mass, (b) calcifications, and (c) facts provided by analysis on available radiology reports.

Some embodiments of the present invention may include one, or more, of the following operations, features, characteristics and/or advantages: (i) evidence driven realization or materialization of hypotheses for higher level first order logical reasoning on entity and relationship predicates in a domain; and/or (ii) mathematically provable inference over the conclusions of an AI system based on a given ontology.

Some embodiments of the present invention may include one, or more, of the following operations, features, characteristics and/or advantages: (i) more complex assertions are computed and simplified to a single fact; (ii) preprocessing allows for more efficient reasoning, that is, while some embodiments create a complex set of comparisons to identify if a server is communicating across a firewall, it is possible that a special purpose function might be able to do this much more compactly by comparing the communication to the netmask; (iii) once information on the above embodiments are gathered, they can be compared to a set of “rules” which state how the world should work (for example, that critical systems must be backed up, and that they should not talk to outside IP (Internet protocol) addresses); and (iv) once set up, some embodiments can apply rules which the clients understand and which make sense from an audit standpoint, since the “facts” are fairly easy to understand and any non-adherence to the rules is easy to compute and explain.

Some embodiments of the present invention may include one, or more, of the following operations, features, characteristics and/or advantages: (i) in modern AI (artificial intelligence) from rule based too deep learning and ensemble systems can leverage existing knowledge and extract facts within a given corpora with great accuracy; (ii) facts can be extracted from the data and the next step is to reason over them in order to draw conclusions from them (traditionally this is accomplished by humans reasoning over the extracted facts and analyzing them in order to obtain the desired actionable insights); (iii) a reasoning system can help the human become more efficient at this particular task of deriving actionable insights; and/or (iv) the knowledge to derive those insights is captured in rule sets.

In order for a reasoning system to be effective at this particular task, the one, or more, of the following questions may arise: (a) are there any rules in a given set which prevent satisfiability, (b) can a system use the knowledge at hand along with the facts contained within a corpus to prove or disprove a specific hypothesis, and (c) can that conclusion of the system be fully explained and supported by the facts, and available knowledge (rule sets) known to the system? In the real world, best practices, guidelines, even business legal policies or processes can be expressed as collections of rule sets that represent them. With the rule sets in hand, they would have to undergo satisfiability verification in order to determine whether or not there are specific conflicting elements that need to be clarified or prioritized differently. This is an iterative process that continues as more conflicting rules are found or even as rules evolve over time. With a satisfiable rule set in hand, and the facts extracted from the corpora, then the system can reason over the facts in order to determine whether there is enough evidence or not to support specific hypothesis and/or conclusions that can be derived from the data. Whether the facts support any specific violations to any of the policies and best practices encoded in the rule sets. In some embodiments, this is accomplished by backward or forward chaining the collections of rule sets as conclusions given the known facts depending on whether a specific hypothesis needs to be proven or a specific goal needs to be reached. In some embodiments, this process also renders a system that can be fully audited down to the facts and rules that support or negate the conclusion.

Some embodiments of the present invention may include one, or more, of the following operations, features, characteristics and/or advantages: (i) provide an evidence driven system and method to realize a satisfiable set of hypothesis for higher level first order logical reasoning on entity and relationship predicates in a domain; (ii) based on the facts, conclusions need to be derived where reasoning helps the human at: (a) the particular task of deriving actionable insights, (b) identifying any rules in a given set which prevent satisfiability, (c) using the knowledge at hand, along with the facts contained within a corpus, to prove or disprove a specific hypothesis, and (d) fully explain and support the proof based on the facts, and available knowledge (rule sets) known to the system; (iii) a reasoner enables: (a) a mathematically provable determination of whether there is enough evidence or not to support specific hypothesis and/or conclusions that can be derived from the data, and (b) whether the facts in the data support any specific violations to any of the policies and best practices encoded in the rule sets; and (iv) best practices or guidelines applications of reasoners can be implemented as a backward or forward chaining collection of rule sets which renders a system to be fully auditable, down to the facts and rules that support or negate any specific conclusion.

Some embodiments of the present invention may include one, or more, of the following operations, features, characteristics and/or advantages: (i) extracts rules from unstructured data in an unsupervised fashion; (ii) extracts rules from fully unstructured, unannotated data without supervision; (iii) describes a system of unsupervised rules extraction for consistent provable and auditable semantic reasoning; (iv) explores the use of first order logic to both manipulate extracted information from unstructured text, but also to empower faster development of high value complex concepts through the use of first order logic to impose ‘pseudo features’ on documents that can be used in further reasoning; (v) applies rules to both structured and unstructured data to determine if the rules support or negate the conclusion; and (vi) able to extract rules from unstructured text in any domain, which later can be used for inference in any kind of application.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM) comprising:
receiving a corpus that includes structured data;
parsing the corpus to obtain parsed corpus information;
applying artificial intelligence to the parsed corpus information to determine a plurality of logical relationships manifested by the corpus; and
expressing, by machine logic, the plurality of logical relationships as a respectively corresponding plurality of logical rule expressions, with each logical rule expression of the plurality of logical rule expressions expressing the respectively corresponding logical relationship as fact(s) with regard to the corpus.

2. The CIM of claim 1 further comprising:
transmitting at least one logical rule expression of the plurality of logical rule expressions in human understandable form and format to a human user(s).

3. The CIM of claim 2 further comprising:
applying natural language processing software to put the at least one transmitted logical rule expression(s) into human understandable form and format, for transmission to human(s).

4. The CIM of claim 1 further comprising:
enabling, by a reasoner, a mathematically provable determination of whether there is enough evidence or not to support a specific hypothesis that can be derived from the parsed corpus information.

5. The CIM of claim 1 further comprising:
enabling, by a reasoner, a mathematically provable determination of whether there is enough evidence or not to support a conclusion that can be derived from the parsed corpus information.

6. The CIM of claim 5 wherein the reasoner is implemented as a backward and/or forward chaining collection of rulesets.

7. A computer-implemented method (CIM) comprising:
receiving a corpus that includes unstructured data;
parsing the corpus to obtain parsed corpus information;
applying artificial intelligence to the parsed corpus information to determine a plurality of logical relationships manifested by the corpus; and
expressing, by machine logic, the plurality of logical relationships as a respectively corresponding plurality of logical rule expressions, with each logical rule expression of the plurality of logical rule expressions expressing the respectively corresponding logical relationship as fact(s) with regard to the corpus.

8. The CIM of claim 7 further comprising:
transmitting at least one logical rule expression of the plurality of logical rule expressions in human understandable form and format to a human user(s).

9. The CIM of claim 8 further comprising:
applying natural language processing software to put the at least one transmitted logical rule expression(s) into human understandable form and format, for transmission to human(s).

10. The CIM of claim 7 further comprising:
enabling, by a reasoner, a mathematically provable determination of whether there is enough evidence or not to support a specific hypothesis that can be derived from the parsed corpus information.

11. The CIM of claim 7 further comprising:
enabling, by a reasoner, a mathematically provable determination of whether there is enough evidence or not to support a conclusion that can be derived from the parsed corpus information.

12. The CIM of claim 11 wherein the reasoner is implemented as a backward and/or forward chaining collection of rulesets.

13. A computer-implemented method (CIM) comprising:
receiving a corpus that includes both unstructured data and structured data;
parsing the corpus to obtain parsed corpus information;
applying artificial intelligence to the parsed corpus information to determine a plurality of logical relationships manifested by the corpus; and
expressing, by machine logic, the plurality of logical relationships as a respectively corresponding plurality of logical rule expressions, with each logical rule expression of the plurality of logical rule expressions expressing the respectively corresponding logical relationship as fact(s) with regard to the corpus.

14. The CIM of claim 13 further comprising:
transmitting at least one logical rule expression of the plurality of logical rule expressions in human understandable form and format to a human user(s).

15. The CIM of claim 14 further comprising:
applying natural language processing software to put the at least one transmitted logical rule expression(s) into human understandable form and format, for transmission to human(s).

16. The CIM of claim 13 further comprising:
enabling, by a reasoner, a mathematically provable determination of whether there is enough evidence or not to support a specific hypothesis that can be derived from the parsed corpus information.

17. The CIM of claim 13 further comprising:
enabling, by a reasoner, a mathematically provable determination of whether there is enough evidence or not to support a conclusion that can be derived from the parsed corpus information.

18. The CIM of claim 17 wherein the reasoner is implemented as a backward and/or forward chaining collection of rulesets.

19. A computer program product (CPP) including:
set of data storage device(s); and
computer code stored on the set of data storage device(s), with the computer code including data and instructions for causing a processor(s) set to perform at least the following operation(s):
receiving a corpus that includes structured data,
parsing the corpus to obtain parsed corpus information,
applying artificial intelligence to the parsed corpus information to determine a plurality of logical relationships manifested by the corpus, and
expressing, by machine logic, the plurality of logical relationships as a respectively corresponding plurality of logical rule expressions, with each logical rule expression of the plurality of logical rule expressions expressing the respectively corresponding logical relationship as fact(s) with regard to the corpus.

20. The CPP of claim 19 wherein the computer code further comprising data and instructions for causing the processor(s) set to further perform the following operation(s):
transmitting at least one logical rule expression of the plurality of logical rule expressions in human understandable form and format to a human user(s).

21. The CPP of claim 20 wherein the computer code further comprising data and instructions for causing the processor(s) set to further perform the following operation(s):
applying natural language processing software to put the at least one transmitted logical rule expression(s) into human understandable form and format, for transmission to human(s).

22. A computer system (CS) including:
A processor(s) set;
set of data storage device(s); and
computer code stored on the set of data storage device(s), with the computer code including data and instructions for causing the processor(s) set to perform at least the following operation(s):
receiving a corpus that includes structured data,
parsing the corpus to obtain parsed corpus information,
applying artificial intelligence to the parsed corpus information to determine a plurality of logical relationships manifested by the corpus, and
expressing, by machine logic, the plurality of logical relationships as a respectively corresponding plurality of logical rule expressions, with each logical rule expression of the plurality of logical rule expressions expressing the respectively corresponding logical relationship as fact(s) with regard to the corpus.

23. The CS of claim 22 wherein the computer code further comprising data and instructions for causing the processor(s) set to further perform the following operation(s):
transmitting at least one logical rule expression of the plurality of logical rule expressions in human understandable form and format to a human user(s).

24. The CS of claim 23 wherein the computer code further comprising data and instructions for causing the processor(s) set to further perform the following operation(s):
applying natural language processing software to put the at least one transmitted logical rule expression(s) into human understandable form and format, for transmission to human(s).
